(19) United States
(12) Patent Application Publication
(10) Pub. No.: US 2010/0117038 A1
(43) Pub. Date: May 13, 2010

(54) Foot-Operated Hydraulic Lift for Trailer

(76) Inventors: Aubrey Benjamin Pinnell, III, Denton, TX (US); Christopher Irgens, Brookfield, WI (US)

Correspondence Address: STORM LLP, BANK OF AMERICA PLAZA, 901 MAIN STREET, SUITE 7100, DALLAS, TX, 75202, US

(21) Appl. No.: 12/570,908

(22) Filed: Sep. 30, 2009

Related U.S. Application Data
(63) Continuation-in-part of application No. 11/091,797, filed on Mar. 28, 2005, now abandoned.

(51) Int. Cl. B60D 1/66; B60S 9/10; B60S 9/12; B60S 9/20

(52) U.S. Cl. 254/420

(57) ABSTRACT

An hydraulically extensible frame is coupled to the hitch portion of a trailer by a pivoting mount. The pivoting mount permits the frame to pivot between a generally vertical operative position and a generally horizontal stowed position. A foot member is secured to an end of the frame opposite the pivoting mount. The foot member engages the ground. An actuator is carried by the frame in a location adapted to be engaged by a foot of a human user when the frame is in the operative or deployed position. The actuator pivots relative to the frame for storage and use as a handle. The actuator selectively extends the frame to raise the hitch portion in response to actuation by the foot of the user.

### BACKGROUND OF THE INVENTION

1. Field of the Invention

The present invention relates to lifting mechanism or apparatus for use with wheeled trailers for lifting a portion of the trailer. More particularly, the present invention relates to such mechanisms or apparatus for lifting a portion of the trailer associated with a hitch to facilitate coupling the hitch and trailer to another vehicle.

2. Summary of the Prior Art

Trailers, as the name implies, typically are coupled to and trail behind a towing vehicle. A ball-and-socket type trailer hitch is conventionally employed to couple the two together. The hitch is usually a forward portion of the trailer referred to as the “tongue.” Such lifts are sometimes called “tongue jacks.”

In many cases, the trailer is not coupled to the towing vehicle until the trailer is already loaded and quite heavy. The load exerted on the tongue and hitch portion of a trailer often is in excess of several hundred pounds. In such cases, attaching the trailer to the vehicle can be challenging because the hitch and tongue of the trailer generally must be raised above the level of the hitch on the vehicle, the two portions of the hitch aligned, and the tongue portion of the trailer lowered to fully engage the hitch. Accordingly, various lifting mechanisms have been associated with such trailers to facilitate the coupling operation. The lifting mechanism also supports the tongue and receiver (or forward) end of the trailer when it is uncoupled from the towing vehicle.

Improvements have been made over time to the lifting mechanisms or apparatus used in conjunction with trailers. Such improvements include the use of electric motors and hydraulics to raise and lower the tongue and hitch of the trailer. Hydraulic lifts are smoother and often safer in operation than mechanical lifts, which can be subject to backlash. U.S. Pat. No. 3,273,858 to Coburn discloses a hand-operated hydraulic elevator for a trailer tongue. U.S. Pat. No. 4,911,460 to DePaula discloses a hand-operated mechanical arrangement. U.S. Pat. No. 5,011,119 to Harrington discloses another hand-operated hydraulic jack.

A typical consumer use for a trailer is to haul a boat. In such applications, the trailer often is partially submerged in water when launching and trailering the boat. Use in or near water militates against the use of electrically actuated systems. Even without the presence of water, electrically operated systems require a connection to an electric power source (usually that of the towing vehicle) and present complications in use, safety and reliability concerns. Hand-pumped hydraulic or hand-cranked mechanical systems avoid these shortcomings, but require the use of at least one of the operator's hands, which leaves only one (if any) hand free to manipulate the hitch or perform other operations. Moreover, the level of the lift and trailer tongue is usually low enough to the ground to make hand operation awkward and possibly unsafe.

A need exists, therefore, for a lift mechanism or apparatus for a wheeled trailer that has simple, reliable construction and that is safe, easy, and convenient to use.

### SUMMARY OF THE INVENTION

It is a general object of the present invention to provide an improved lift for a wheeled trailer to be towed behind a vehicle. This and other objects of the invention are attained by providing a lift comprising an inner sleeve and a foot member coupled to a lower end of the inner sleeve. An outer sleeve is concentrically and slidingly mounted over the inner sleeve. A mount is secured to an upper end of the outer sleeve opposite the foot member for securing the frame to the trailer at a location proximal to the hitch. An hydraulic pump is contained within the inner sleeve. A rod is selectively extensible from the hydraulic pump. An upper end of the rod is coupled to the upper end of the outer sleeve. A foot-pedal actuator is operatively connected to the hydraulic pump to selectively actuate the hydraulic pump, extend the rod, and move the outer sleeve relative to the inner sleeve. The pedal actuator is mounted at a lower end of the inner sleeve and configured to be engaged and operated by the foot of a human user. A positive stop member is arranged between the inner and outer sleeves, the stop member configured to stop relative axial or longitudinal movement between the sleeves and mechanically fix the lift in a selected position.

According to a preferred and illustrative embodiment of the invention, the foot member includes a wheel configured to roll on the ground surface.

According to a preferred and illustrative embodiment of the invention, a pressure-relief valve is accessible to a user to selectively relieve pressure from the hydraulic pump.

According to a preferred and illustrative embodiment of the invention, the mount permits the frame to pivot from an operative position in which the sleeves are generally perpendicular to the ground surface and a stowed position in which the sleeves are oriented at an acute angle to the ground surface.

According to a preferred and illustrative embodiment of the invention, the actuator further includes a biasing member to maintain the actuator in an operative position.

According to a preferred and illustrative embodiment of the invention, at least one key and keyway is disposed between the inner and outer sleeves to prevent relative rotation therebetween.

According to a preferred and illustrative embodiment of the invention, the pedal actuator pivots between a folded position adjacent the inner and outer sleeves, and a deployed position for actuation by the foot of a human user standing on the ground surface.

According to a preferred and illustrative embodiment of the invention, the key and keyway further comprises a longitudinally extending slot formed in an exterior of the inner sleeve; and a longitudinally extending key formed in an interior of the outer sleeve and registering with the slot in the inner sleeve upon assembly of the two.

Other objects, features, and advantages of the present invention will become apparent with reference to the drawings and detailed description, which follows.

### BRIEF DESCRIPTION OF THE DRAWINGS

FIG. 1 is an elevation view of a wheeled trailer including the lifting apparatus according to the present invention.

FIG. 2 is an enlarged elevation view of the lifting apparatus of FIG. 1 in a deployed or near-vertical position.

FIG. 3 is an elevation view of the lifting apparatus of FIGS. 1 and 2 pivoted into a stowed or near-horizontal position.

FIGS. 4 and 5 are an enlarged elevation view, partially in section, of the lifting apparatus of FIGS. 1, 2, and 3.

FIG. 6 is an enlarged, fragmentary view, partially in section, of the attachment or mounting of a portion of lifting apparatus according to the present invention to a portion of the trailer.

FIG. 7 is an elevation view of a second illustrative embodiment of the lift of the present invention.

FIG. 8 is a fragmentary longitudinal section of a lower portion of the lift of FIG. 7, taken along section line 8-8 of FIG. 7.

FIG. 9 is a fragmentary longitudinal section of an upper portion of the lift of FIG. 7, the section being rotated 90 degrees from that of FIG. 8.

FIG. 10 is a cross-section view of the lift of FIG. 7, taken along section line 10-10 of FIG. 7.

### DETAILED DESCRIPTION

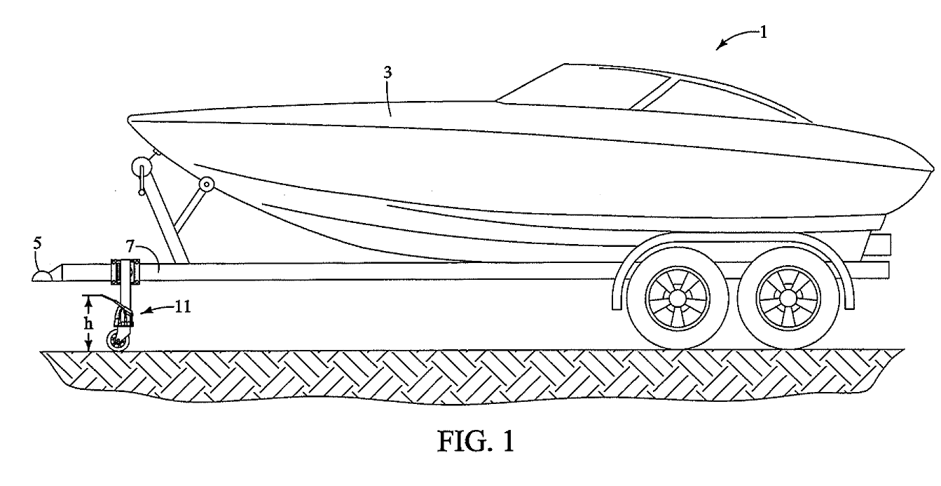

Referring now to the Figures and particularly to FIG. 1, the numeral 1 designates a wheeled trailer of the type with which the present invention is employed. The present invention is particularly adapted to those wheeled trailers that are adapted to haul or carry boats 3, such as that illustrated in FIG. 1, because of the relatively great loaded weight of such trailers and the frequency with which they are coupled and uncoupled from a towing vehicle. As can be seen, trailer 1 has a hitch 5 at a forward portion thereof, which is secured to a tongue portion 7 of trailer 1. Typically, hitch 5 is a socket member that registers with a corresponding hitch ball (not shown) on a towing vehicle (also not shown).

A lifting mechanism or apparatus (“lift”) 11 according to the present invention is secured to a tongue portion 7 of trailer proximal to or near hitch receiver 5. As shown in FIG. 1, lift 11 serves as a third wheel or support to maintain trailer 1 in a generally level orientation when trailer 1 is not coupled to a towing vehicle. A lift 11 according to the present invention finds particular utility in those trailers 1 adapted to carry or haul boats because such trailers often are extremely heavy and incapable of being manipulated solely by a user, without the assistance of a mechanical advantage.

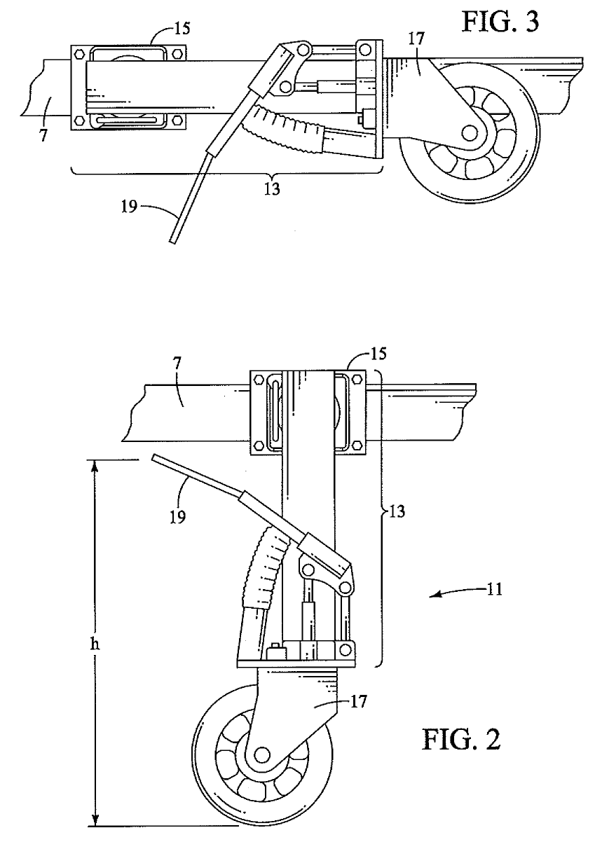

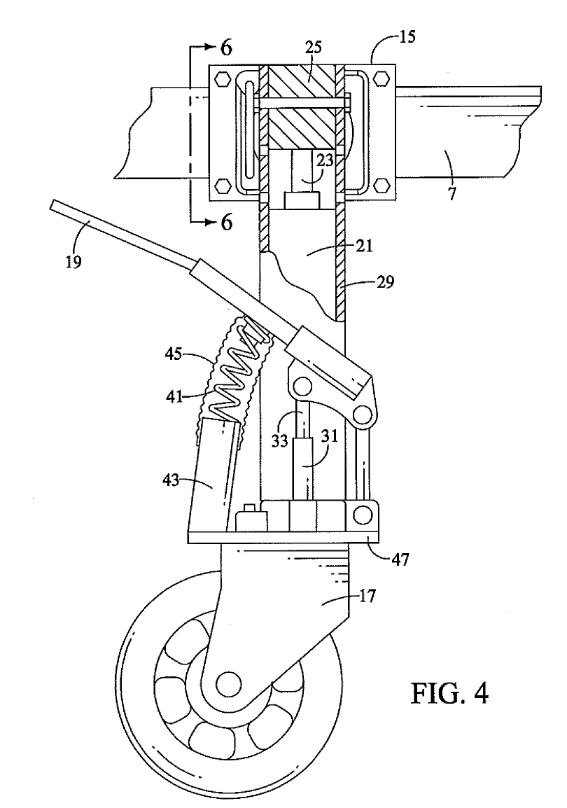

FIGS. 2 and 3 are enlarged elevation views of the lift 11 according to the present invention illustrating the lift in a deployed or near-vertical position (FIG. 2) and a stowed or near-horizontal position (FIG. 3). Lift 11 generally comprises a hydraulically extensible frame 13 that is coupled to a generally horizontally extending portion of trailer tongue 7 by a pivoting mount or bracket 15. At its lower end, frame 13 terminates in a foot member, which is preferably a wheel but may be another type of support. Additionally, frame 13 (and lift 11) is provided with an actuator 19 in the form of a foot pedal. Foot pedal 19 is arranged to be no higher than a selected height h of about 18-24 inches so that it is adapted to be engaged and operated by a foot of a human user.

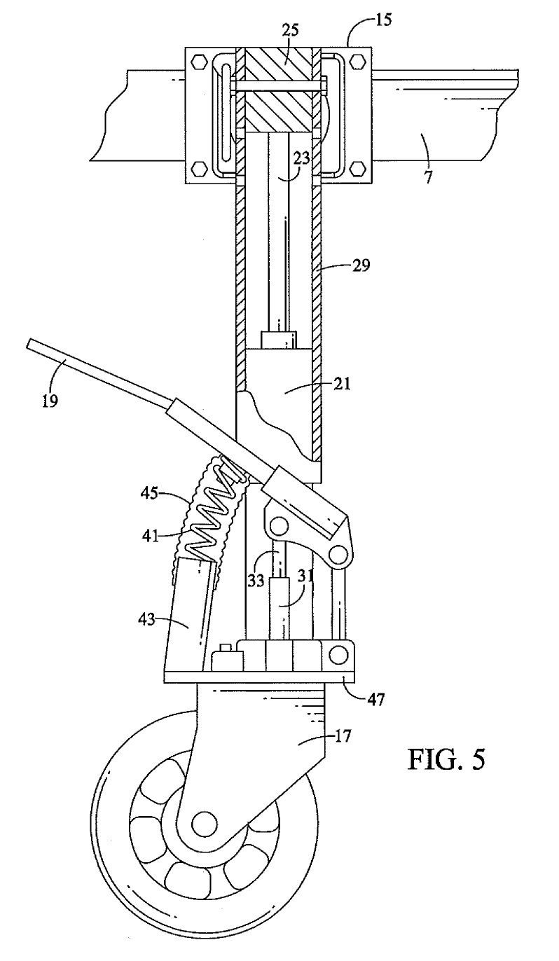

FIGS. 4 and 5 are enlarged elevation views, partially in section, of lift 11 according to the present invention. FIG. 4 depicts lift 11 in a retracted or fully compressed stated while FIG. 5 depicts lift 11 in an extended state in which tongue 7 of trailer 1 is being (or has been) raised by lift 11. The hydraulically extensible frame (13 in FIG. 2) of lift 11 comprises a conventional bottle jack, which has an hydraulic cylinder 21 and a rod 23 extending or protruding a selected and variable distance from cylinder 21. According to the preferred embodiment of the present invention, the bottle jack is commercially available, such as the AC-Delco® Hydraulic Bottle Jack, Model 34112.

Rod 23 terminates at its end in a cylindrical member 25, which preferably is a steel cylinder welded to the end of rod 23. Rod 23 preferably has a threaded exterior and its protrusion from cylinder 21 is adjustable by rotating rod 23 relative to cylinder 21. This provides an adjustment of the overall height of frame 13 to accommodate towing vehicles with differing bumper (and hitch) heights. A conventional bolt 27 extends through cylindrical member 25 to couple a tubular frame member 29 to rod 23. Rod 23 is the portion of the bottle jack that extends upwardly from cylinder 21 responsive to hydraulic actuation of the bottle jack. Tubular frame member 29 thus moves up and down with rod 23 relative to cylinder 21. Tubular frame member 29 is dimensioned to slide concentrically over and cover cylinder 21. In the fully compressed position depicted in FIG. 4, cylinder 21 of the bottle jack is almost completely covered by frame member 29.

Foot pedal or actuator 19 is coupled to an actuator cylinder 31 and actuator rod 33. Actuator rod and cylinder 31, 33 are part of the bottle jack and operate to exert pressure on the hydraulic fluid in cylinder 21 of the bottle jack, thereby extending rod 23 from cylinder 21 and raising or extending the frame of lift 11, in turn raising tongue 7 of trailer 1. As noted previously, actuator pedal 19 is designed, intended, and adapted to be operated by the foot of a human user. Accordingly, it is preferably no higher than a height h of about 18 inches from the ground when lift 11 is in the deployed position. Height h should not exceed 24 inches if an average human operator is to use lift 11 without risking the loss of balance.

In addition to being positioned to be engaged by a foot, foot pedal or actuator 19 is biased into an upward position by a compression coil spring or biasing member 41. Spring 41 maintains pedal 19 in the upward position at all times (except when pedal 19 is depressed by an operator) and permits the operator's foot to do actuation work only on the downward stroke of pedal 1. Spring 41 is captured between pedal 19 and base plate 47 of the bottle jack by a tube 43. The upper extent of spring 41 is covered with a plastic or metallic bellows 45 for aesthetic and functional purposes (to improve appearance and to keep materials from being pinched or caught in spring 41).

A stopcock 37 functions to release pressure within the bottle jack, thereby permitting rod 23 and tubular frame 29 to compress or retract relative to bottle jack cylinder 21, in turn lowering tongue 7 of trailer 1.

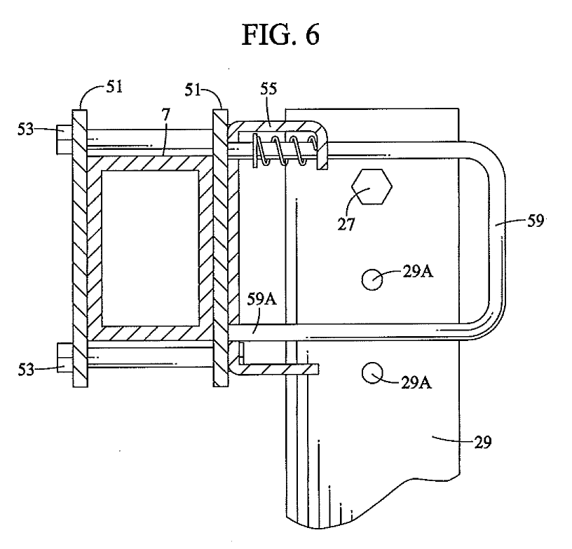

FIG. 6 is an elevation view, partially in section, of pivoting mount 15, taken along the section line 6-6 of FIG. 5. Mount 15 comprises a pair of parallel, spaced-apart plates 51 that are secured to either side of the box-girder of trailer tongue 7 by four bolts 53, two of which are shown in FIG. 6. A bracket 55 is mounted for rotation on one of plates 51 by a pivot or axle 57. Bracket 55 is, in turn, welded to tubular frame member 29.

A U-shaped, spring-loaded handle 59 is secured to bracket 55. One end 59A of handle 59 extends through an aperture in bracket 55 and into an aperture in plate 51, thereby securing bracket 55 and tubular frame member 29 of lift 11 against rotation relative to trailer tongue 7. By pulling outward (to the right in FIG. 6) on handle 59, end 59A is disengaged from the aperture in plate 51, freeing bracket 55, frame 29 and lift 11 to pivot between the stowed and deployed positions illustrated in FIGS. 2 and 3. Although a horizontal stowed position is shown in FIG. 3, it is actually preferred that the lower end of lift 11 be angled slightly downward to permit drainage of water from the assembly. In this stowed position, lift 11 should describe an acute angle relative to tongue 7 or the ground surface of about 15-30 degrees.

FIG. 6 also illustrates a fixed height adjustment provided for lift 11 by holes or apertures 29A formed in the wall of tubular frame member 29. By removing bolt 27, moving frame member 29 relative to cylindrical member (25 in FIGS. 4 and 5) into alignment with one of the other apertures 29A, and re-inserting bolt 27, the overall height of lift 11 can be adjusted in a fixed fashion, without regard to the level of extension of rod (23 in FIGS. 4 and 5) relative to cylinder (21 in FIGS. 4 and 5) or tubular member 29.

In operation, the first illustrative or preferred embodiment of lift 11 is coupled to tongue 7 of trailer near hitch 5 as shown in FIGS. 1 and 6. Frame 13 of lift 11 is pivoted to the deployed or near-vertical position as shown in FIG. 2. Lift then is capable of supporting the forward or front end of trailer 1, even under load. To couple hitch to a towing vehicle, foot pedal 19 is actuated by an operator's foot, extending rod 23 from cylinder 21 and extending tubular frame 29 relative to foot member 17, thereby raising tongue 7 relative to the ground. Tongue 7 and hitch 5 may then be aligned, with the assistance of wheeled foot member 17, over the hitch ball. Stopcock 37 is then released to permit rod 23 to retract into cylinder 21 and frame member 29 to retract relative to foot member 17. Tongue 7 and hitch 5 then are lowered into engagement with the hitch ball. The process is essentially reversed to disengage or uncouple trailer 1 from the towing vehicle. Additionally, by manipulating handle 59 of mount 15, lift 11 may be pivoted between stowed and deployed positions to facilitate towing trailer 1 over uneven terrain.

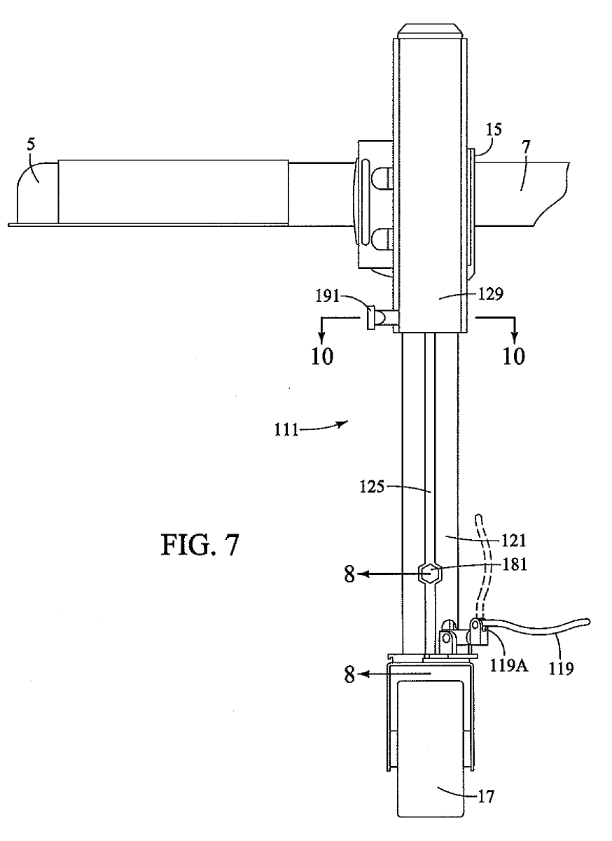

FIGS. 7 through 10 illustrate another embodiment of a trailer lift 111 according to the present invention. This embodiment employs a purpose-built hydraulic pump assembly, as opposed to the bottle jack of the embodiments of FIGS. 1 through 6. This embodiment of trailer lift 111 functions virtually identically (except as noted below) and appears similar to the embodiment of FIGS. 1 through 6. Generally like structures are numbered similarly.

FIG. 7 shows trailer lift 111 in a deployed (vertical) and extended position. Lift 111 is shown coupled to the tongue 7 proximate the hitch receiver portion 5 of a trailer (shown in FIG. 1). Lift 111 is coupled to trailer tongue 7 by a pivoting bracket 15, substantially similar to that illustrated with reference to FIGS. 1 through 6.

At the lowermost end of lift 111, a foot member or wheel 17 is arranged in a swiveling, caster fashion. A foot pedal 119 is pivotally secured by joint 119A and folds with respect to lift 111, as indicated by the phantom lines for storage “out of the way.” The pivoting foot pedal also functions as a handle or grip to assist a user in moving lift 111 between the deployed or vertical, and stowed positions shown in FIGS. 2 and 3. In the stowed position, lift 111 preferably occupies a position in which the longitudinal axis of lift 111 describes an acute angle with reference to the ground surface or the tongue 7 portion of trailer to facilitate drainage of water from the assembly.

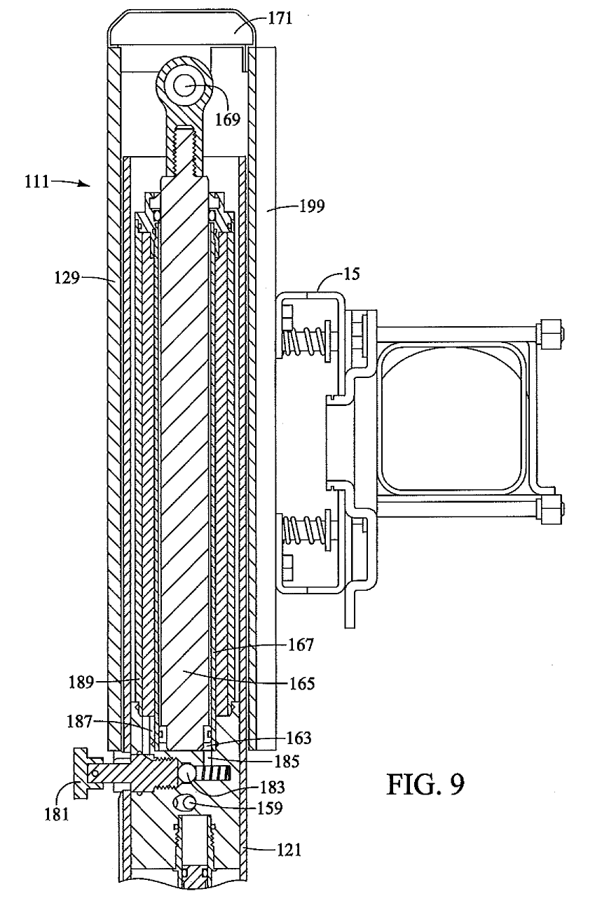

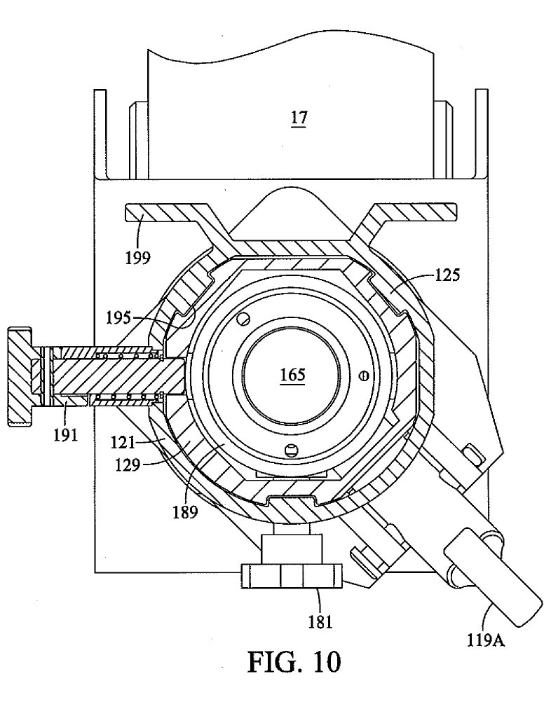

An upper cylinder or sleeve 129 slides over and reciprocates or telescopes with respect to an inner cylinder or sleeve 121 in response to actuation of lift 111 by foot pedal 119. Upper cylinder 129 is coupled by bolts and a flange (199 in FIGS. 9 and 10) to bracket 15 to permit deployment and stowage. Actuation of pedal 119 by the foot of a user selectively extends upper cylinder 129 relative to inner cylinder 121 and foot or wheel 17, thus effectuating lifting of trailer tongue 7 and hitch receiver 5. Again, foot pedal should be arranged to be engaged by the foot of a user and should be no more than about 18-24 inches off the ground in its position of maximum upward travel.

As will be described in greater detail with reference to FIG. 10, outer cylinder or sleeve 129 is provided with a positive stop member 191 in the form of a spring-loaded cylinder that selectively engages a receptacle in inner cylinder 121. Inner cylinder 121 (in the hydraulic assembly contained therein) includes a bypass valve 181. Additionally, at least one (three are illustrated in FIG. 10, only one of which is shown in FIG. 7) longitudinally or axially extending groove, recess, or keyway 125 is provided in inner cylinder or sleeve 121, which maintains alignment and prevents rotation between inner and outer cylinders or sleeves 121, 129.

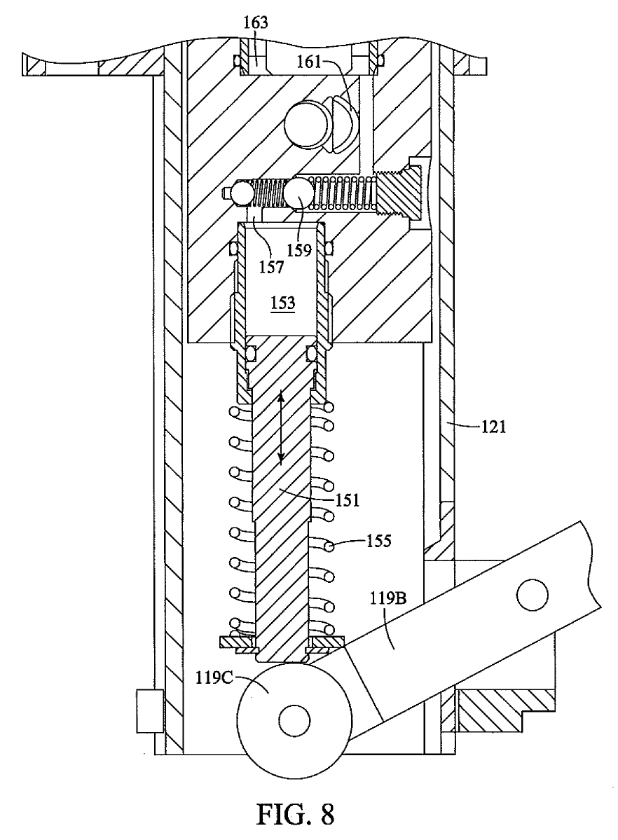

Referring now to FIG. 8, a longitudinal section view of the lowermost extent of inner cylinder 121 is shown. Wheel 17 and associated hardware are omitted from FIG. 8 for clarity. As illustrated, a portion of foot pedal 119B acts as a lever through roller element 119C upon a piston 151, which reciprocates in a bore 153. A coil spring biasing member 155 is provided to bias or urge piston 151 in a normally downward direction. Reciprocation of piston 151 in bore 153 pumps or pressurizes hydraulic fluid, which passes through a passage 157 through a check valve 159, another passage 161, and into an hydraulic chamber 163 (shown in greater detail in FIG. 9). Check valve 159 prevents return of hydraulic fluid from chamber 163 into bore 153. Thus, actuation of foot pedal 119 pumps or pressurizes hydraulic fluid and causes it to raise or extend upper cylinder 129 relative to lower cylinder or sleeve 121, as shown in greater detail with reference to FIG. 9.

FIG. 9 is another longitudinal section view of an upper portion of trailer lift 111 according to this embodiment of the present invention. The section of FIG. 9 is rotated 90° from the longitudinal section of FIG. 8. Fluid pumped into hydraulic chamber 163 acts on a piston or hydraulic rod 165 to cause rod 165 to extend upward. A cylindrical sleeve 167 surrounds hydraulic rod 165 and defines the exterior of hydraulic chamber 163. The upper end of rod 165 is coupled by a pivoting joint 169 to a cap 171, which is in turn secured to an upper end of outer cylinder or sleeve 129. Thus, extension of rod 165 responsive to pumping of fluid by foot pedal 119 causes relative movement between outer cylinder or sleeve 129, coupled to the trailer, and inner cylinder or sleeve 121, coupled to foot or wheel 17. Raising of the trailer by lift 111 is thereby accomplished.

Hydraulic chamber 163 is in fluid communication with a pressure-relief valve 181, operated by a thumb screw, through passage 185. When pressure-relief valve 181 is open, hydraulic fluid flows from chamber 163 through passage 185, past ball-check 183 (which prevents reverse flow), into passage 187 and into a reservoir defined between sleeve 167 and another, larger diameter sleeve 189. Another passage (not shown) communicates fluid from the reservoir back to bore 153 through a check valve (the second ball shown in FIG. 8 adjacent ball 159). Thus, fluid circulates freely from reservoir 183, to bore 153, and to chamber 163. When valve 181 is open, upper cylinder 129 and associated rod 165 are free to move (retract under weight) relative to one another. Pressure-relief valve 181 should be configured either with a check valve or in such a manner that it cannot easily be removed to prevent loss of fluid from the system.

When pressure-relief valve 181 is closed, fluid is prevented from exiting chamber 163 and relative movement between cylinders or sleeves 121, 129 is prevented, except extension in response to pumping of fluid by actuation of foot pedal 119 is permitted and maintained by pressure in chamber 163. Thus, lift 111 may be maintained in an extended (or retracted) position by closing pressure relief valve 181. A more positive mechanical stop 191 is also provided, as discussed in greater detail with reference to FIG. 10, below.

FIG. 10 is a cross-section view through positive stop 191, showing various features of trailer lift 111 according to this embodiment of the invention. FIG. 10 illustrates that outer sleeve or cylinder 129 is a close sliding fit over inner sleeve or cylinder 121. A plurality of keys or lands (three are illustrated) on the interior surface of outer sleeve 129 engage with corresponding grooves, recesses or keyways 125 formed in exterior surface of inner cylinder 121. This insures that both cylinders or sleeves 121, 129 are maintained in proper axial and rotational alignment, thus avoiding or preventing bending and torsional stresses on hydraulic components on the interior of sleeve 121. Further, sleeves 121, 129 cover or shroud the components of the hydraulic system from exposure to road debris and the like both in the extended and retracted positions. A longitudinally extending flange 199 is provided on one side of sleeve 129 to permit sleeve 129 (and remaining components of lift) to be secured by bolts or rivets to bracket 15.

As depicted, a positive-stop member 191, in the form of a spring-loaded cylinder, is carried on the exterior of outer sleeve 129. Stop member 191 has a knob and is arranged so that twisting the knob in one direction or the other moves the cylinder in and out. Thus, when the knob is twisted and the cylinder moves inwardly, it engages one of a plurality of corresponding apertures formed in inner sleeve 121 to secure inner and outer cylinders or sleeves, 121, 129 against movement relative to one another. An aperture may be provided in inner sleeve 121 at an upper position corresponding to an extended position of lift 111, and a lower position, corresponding to a retracted position, and a plurality of apertures provided in between to fix upper and lower sleeves 121, 129 at selected extended heights that may correspond, for example, to common hitch or bumper heights. Upon alignment of stop member 191 with a selected one of the aperture, and twisting of the knob, the spring biases the cylinder into engagement with the aperture, preventing relative movement between the inner and outer sleeves or cylinders 121, 129. Stop member 191 must be pulled outwardly and twisted to the retracted position by the operator to raise or lower lift 111. Because trailer lift 111 is intended to be used in connection with a trailer in both stationary and over-the-road applications, it is important that lift be securely fastened in both extended and retracted positions so that the position of lift 111 is not dependent solely upon hydraulics.

In operation, pivoting bracket 15 is employed to move lift 111 between deployed and stowed positions. In the deployed position, pressure-relief valve 181 is opened and positive stop 191 is released (by pulling outwardly) to permit foot or wheel 17 to extend or lower into engagement with the ground surface. Pressure-relief valve 181 then is closed and foot pedal 119 is unfolded and actuated to extend lift 111 and raise trailer tongue 7 and hitch receiver 5 (for example to disconnect hitch 5 from a vehicle). At full extension, spring-loaded stop member 191 engages and mechanically secures lift 111 in the extended position. To lower lift (and tongue 7 and hitch receiver 5) positive stop member 181 is disengaged (if engaged), and pressure-relief valve 181 opened to permit lift to lower under load. Upon full retraction, stop member 191 engages, mechanically securing lift 111 in the retracted position. Lift 111 then can be rotated into the stowed position for travel over-the-road by pulling on folding foot pedal 119 to rotate bracket 15. Foot pedal 119 then is folded into the stowed position for travel.

According to the preferred embodiment of the present invention, outer sleeve or cylinder 129 is about three inches in diameter. The overall length of lift 111 is about 39 inches fully extended and 10 inches shorter in fully retracted position. Thus, particularly second illustrative embodiment of the present invention provides a safe, compact, strong lift that is particularly adapted to use with boat trailers, where wet conditions can be expected. The design is also configured to be especially safe and resistant to damage while the trailer is being pulled over-the-road. The hydraulic components are all enclosed within a structure and exposure to bending and torsional forces is largely avoided.

The lift according to the present invention has a number of advantages. It is hydraulic, so it is smooth in operation and avoids the potentially dangerous “kickback” and backlash sometimes encountered in purely mechanical systems. It is not electrically operated, making it safe and reliable even in marine environments. It is operated by the foot and leg muscles of the operator, which are stronger than hand and arm muscles. Further, foot operation or actuation permits the operator to keep his or her head or face away from trailer and hitch components for safety in the event of failure. Foot-pedal actuation allows the user to have both hands free and to stand mostly erect in use. This allows the user to have a better field of vision while coupling an uncoupling the hitch and launching or trailer boats. The lift according to the present invention is simple in construction and operation, making manufacturing, repair, and replacement inexpensive.

The invention has been described with reference to preferred or illustrative embodiments thereof. It is thus not limited, but is susceptible to variation and modification without departing from the scope of the invention.

1. A lift for a wheeled trailer configured to be coupled to a vehicle by a hitch, the lift comprising:
an inner sleeve;
a foot member coupled to a lower end of the inner sleeve;
an outer sleeve concentrically and slidingly mounted over the inner sleeve;
a mount secured to an upper end of the outer sleeve opposite the foot member, the mount for securing the frame to the trailer at a location proximal to the hitch;
an hydraulic pump contained within the inner sleeve;
a rod selectively extensible from the hydraulic pump, an upper end of the rod coupled to the upper end of the outer sleeve;
a pedal actuator operatively connected to the hydraulic pump to selectively actuate the hydraulic pump, extend the rod, and move the outer sleeve relative to the inner sleeve, the pedal actuator being mounted at a lower end of the inner sleeve and configured to be engaged and operated by the foot of a human user; and
a positive stop member arranged between the inner and outer sleeves, the stop member configured to stop relative movement between the sleeves and mechanically fix the lift in a selected position.

2. The lift according to claim 1, wherein the foot member includes a wheel configured to roll on the ground surface.

3. The lift according to claim 1, further comprising a pressure-relief valve accessible to a user to selectively relieve pressure from the hydraulic pump.

4. The lift according to claim 1, wherein the mount permits the frame to pivot from an operative position in which the sleeves are generally perpendicular to the ground surface and a stowed position in which the sleeves are generally parallel to the ground surface.

5. The lift according to claim 1, wherein the actuator further includes a biasing member to maintain the actuator in an operative position.

6. The lift according to claim 1 further comprising at least one key and keyway disposed between the inner and outer sleeves to prevent relative rotation therebetween.

7. The lift according to claim 1, wherein the pedal actuator pivots between a folded position adjacent the inner and outer sleeves, and a deployed position for actuation by the foot of a human user standing on the ground surface.

8. The lift according to claim 6, wherein the key and keyway further comprises:
a longitudinally extending slot formed in an exterior of the inner sleeve; and
a longitudinally extending key formed in an interior of the outer sleeve and registering with the slot in the inner sleeve upon assembly of the two.

9. A lift for a wheeled trailer configured to be coupled to a vehicle by a hitch, the lift comprising:
a frame including:
an inner sleeve;
an outer tubular sleeve concentrically and slidingly mounted over the inner sleeve, wherein the inner and outer sleeves are secured against rotation relative to one another;
a foot member coupled to a lower end of the frame;
a pivoting mount secured to an upper end of the frame opposite the foot member, the mount securing the frame to the trailer at a location proximal to the hitch;
an hydraulic pump contained within the inner sleeve of the frame;
a rod selectively extensible from the hydraulic pump, an upper end of the rod coupled to the upper end of the outer sleeve;
a pedal actuator operatively connected to the hydraulic pump to selectively actuate the hydraulic pump, extend the rod, and move the outer sleeve relative to the inner sleeve, the pedal actuator being pivotally mounted at a lower end of the frame and movable between folded and deployed positions, the pedal actuator in the deployed position being configured to be engaged and operated by the foot of a human user; and
a positive stop member arranged between the inner and outer sleeves, the stop member configured to stop relative movement between the sleeves and mechanically fix the lift in a selected position.

10. The lift according to claim 9, wherein the foot member includes a wheel configured to roll on the ground surface.

11. The lift according to claim 9 further comprising a pressure-relief valve accessible to a user to selectively relieve pressure from the hydraulic pump.

12. The lift according to claim 9, wherein the mount permits the frame to pivot from an operative position in which the sleeves are generally perpendicular to the ground surface and a stowed position in which the sleeves are generally parallel to the ground surface.

13. The lift according to claim 9 further comprising at least one key and keyway disposed between the inner and outer sleeves to prevent relative rotation therebetween.

14. A lift for a wheeled trailer configured to be coupled to a vehicle by a hitch, the lift comprising:
an inner sleeve;
a wheel coupled to a lower end of the inner sleeve;
an outer sleeve concentrically and slidingly mounted over the inner sleeve;
a key on one of the inner and outer sleeves, the key engaging a keyway on another of the inner and outer sleeves to prevent relative rotation therebetween
a pivoting mount secured to an upper end of the outer sleeve opposite the foot member, the mount for securing the frame to the trailer at a location proximal to the hitch, the pivoting mount permitting the inner and outer sleeves to pivot relative to the trailer between deployed and stowed positions;
an hydraulic pump contained within the inner sleeve;
a rod selectively extensible from the hydraulic pump, an upper end of the rod coupled to the upper end of the outer sleeve;
a pedal actuator operatively connected to the hydraulic pump to selectively actuate the hydraulic pump, extend the rod, and move the outer sleeve relative to the inner sleeve, the pedal actuator being pivotally mounted at a lower end of the frame and movable between folded and deployed positions, the pedal actuator in the deployed position being configured to be engaged and operated by the foot of a human user;
a spring-loaded stop member arranged between the inner and outer sleeves, the stop member configured to engage an aperture in the inner sleeve to stop relative movement between the sleeves and mechanically fix the lift in a selected position; and
a pressure-relief valve accessible to a user to selectively relieve pressure from the hydraulic pump.
